(19) United States
(12) Patent Application Publication
(10) Pub. No.: US 2013/0318377 A1
(43) Pub. Date: Nov. 28, 2013

(54) INFORMATION PROCESSOR, COMPUTER PROGRAM PRODUCT, AND POWER SAVING SETTING METHOD

(71) Applicant: KABUSHIKI KAISHA TOSHIBA, Tokyo (JP)

(72) Inventor: Taisuke Furuya, Hamura-shi (JP)

(73) Assignee: KABUSHIKI KAISHA TOSHIBA, Tokyo (JP)

(21) Appl. No.: 13/959,966

(22) Filed: Aug. 6, 2013

Related U.S. Application Data
(63) Continuation of application No. PCT/JP2013/057578, filed on Mar. 12, 2012.

(30) Foreign Application Priority Data
Apr. 10, 2012 (JP) 2012-089534

(51) Int. Cl. G06F 1/32

(52) U.S. Cl. CPC G06F 1/3206
USPC 713/320

(57) ABSTRACT

According to one embodiment, information processor includes: setting module; processor; monitoring module; analyzer; and notification module. The setting module specifies first value as first power saving function. The processor controls modules in accordance with the first value. The monitoring module accumulates in storage device information indicating usage of the modules as log. The analyzer determine based on the log whether power saving is achieved by the first power saving function when the processor controls the modules in accordance with the first value. The notification module notifies a user to use a second power saving function when power saving by the first power saving function is not achieved. Here, the second power saving function is expected to provide a larger power saving effect than that of the first power saving function, and realizes power saving in accordance with the usage of the modules.

### CROSS-REFERENCE TO RELATED APPLICATIONS

This application is a continuation of PCT international application Ser. No. PCT/JP2013/057578, filed on Mar. 12, 2013, which designates the United States, incorporated herein by reference, and which is based upon and claims the benefit of priority from Japanese Patent Application No. 2012-089534, filed on Apr. 10, 2012, the entire contents of which are incorporated herein by reference.

### FIELD

Embodiments described herein relate generally to an information processor, a computer program product, and a power saving setting method.

### BACKGROUND

In recent years, various types of personal computers having a power saving function have been developed. Such personal computers are provided with a utility program by which a user can set a parameter for power saving, for example. By using the utility program, the user can set a time until a personal computer is put into an idle state, for example. By exerting such a utility program, a personal computer is put into an idle state after the set time elapses without any operation performed by the user. As a result, power consumption can be reduced.

Furthermore, in recent years, there has been developed a computer that can offer power saving setting depending on usage of the computer by a user.

In the conventional technology, power saving setting depending on usage of the computer is simply offered to the user. Practically, many users perform no power saving setting positively while recognizing the need for power saving setting.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an appearance of a computer according to an embodiment;

FIG. 2 is an exemplary block diagram of a hardware configuration of the computer in the embodiment;

FIG. 3 is an exemplary block diagram of a functional configuration of a power saving setting application in the embodiment;

FIG. 4 is an exemplary front view of a power saving setting screen displayed by a power saving function setting module in the embodiment;

FIG. 5 is an exemplary front view of a screen with a guidance message in the embodiment; and

FIG. 6 is an exemplary flowchart of monitor power saving utility prompting processing in the embodiment.

### DETAILED DESCRIPTION

In general, according to one embodiment, an information processor comprises: a power saving function setting module; a power saving processor; a monitoring module; an analyzer; and a notification module. The power saving function setting module is configured to specify a first value as a first power saving function. Here, the first value is set to a power saving parameter for power saving by modules. The power saving processor is configured to control the modules in accordance with the first value of the power saving parameter in the first power saving function. The monitoring module is configured to accumulate in a storage device information indicating usage of the modules as log information. The analyzer is configured to determine based on the accumulated log information whether power saving is achieved by the first power saving function when the power saving processor controls the modules in accordance with the first value of the power saving parameter in the first power saving function. The notification module is configured to notify a user to use a second power saving function when power saving by the first power saving function is not achieved. Here, the second power saving function is expected to provide a larger power saving effect than a power saving effect of the first power saving function and is configured to realize power saving in accordance with the usage of the modules.

A configuration of an information processor according to an embodiment is described below with reference to the accompanying drawings. The information processor according to the embodiment is embodied as an all-in-one personal computer (hereinafter, referred to as a computer), for example. The information processor is not limited to an all-in-one personal computer, and can be applied to various types of computer devices.

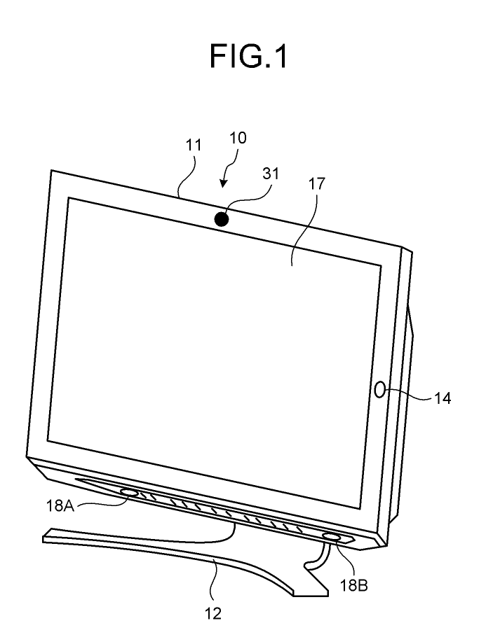

FIG. 1 is a perspective view of an appearance of a computer 10 according to the embodiment. As illustrated in FIG. 1, the computer 10 comprises a computer main body 11 and a support 12 that supports the computer main body 11. The computer main body 11 houses a display device comprising a liquid crystal display (LCD) 17.

The computer 10 comprises a camera 31 on the upper part of the computer main body 11. Furthermore, the computer 10 is provided with a power switch 14 for turning ON/OFF the computer 10, and speakers 18A and 18B, for example, in the computer main body 11.

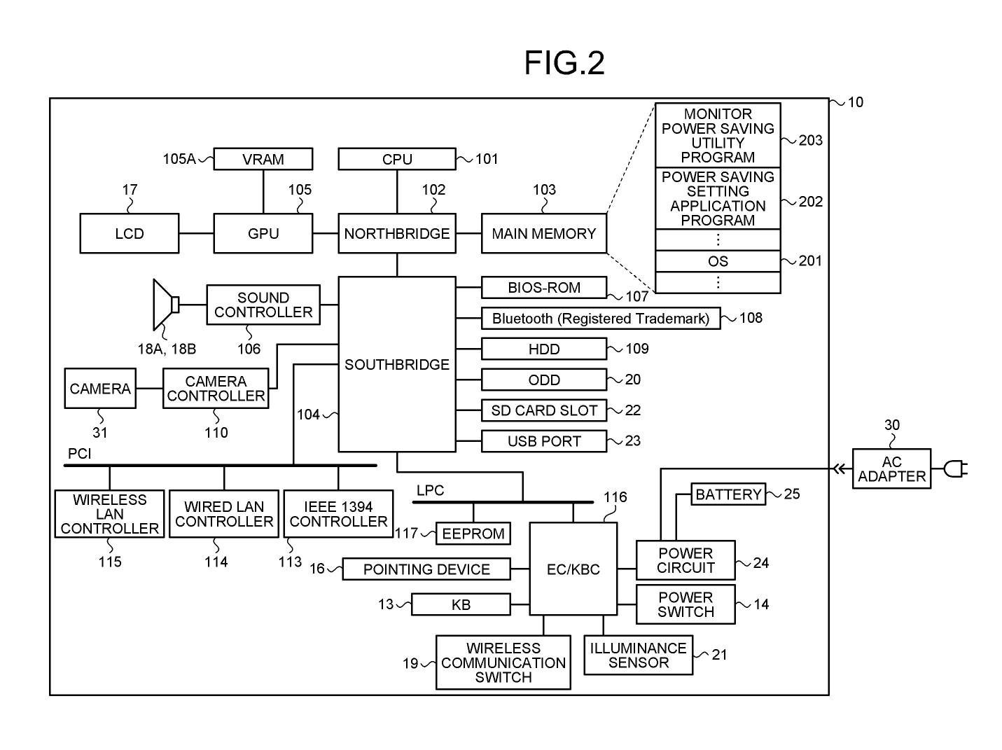

A system configuration of the computer 10 will now be described. FIG. 2 is a block diagram of a hardware configuration of the computer 10 in the embodiment.

As illustrated in FIG. 2, the computer 10 comprises a central processing unit (CPU) 101, a Northbridge 102, a main memory 103, a Southbridge 104, a graphics processing unit (GPU) 105, a video random access memory (VRAM) 105A, a sound controller 106, a basic input/output system read-only memory (BIOS-ROM) 107, a Bluetooth (registered trademark) module 108, a hard disk drive (HDD) 109, a camera controller 110, an optical disk drive (ODD) 20, a Secure Digital (SD) card slot 22, a universal serial bus (USB) port 23, the camera 31, an Institute of Electrical and Electronics Engineers (IEEE) 1394 controller 113, a wired local area network (LAN) controller 114, a wireless LAN controller 115, an embedded controller/keyboard controller integrated circuit (IC) (EC/KBC) 116, an electrically erasable programmable read-only memory (EEPROM, registered trademark) 117, a keyboard (KB) 13, the power switch 14, a pointing device 16, such as a mouse, a wireless communication switch 19, an illuminance sensor 21, a power circuit 24, a battery 25, and an alternate current (AC) adapter 30, for example.

The CPU 101 is a processor that controls operations of the computer 10, and executes various types of application programs, such as an operating system (OS) 201, a power saving setting application program 202, and a monitor power saving utility program 203, loaded onto the main memory 103 from the HDD 109. The CPU 101 also executes the BIOS stored in the BIOS-ROM 107. The BIOS is a computer program for controlling hardware.

The monitor power saving utility program 203 is software that prevents display from being continued in a state where the LCD 17 is not being viewed, by performing ON/OFF control on the LCD 17 depending on the detection state of a face of a user with the camera 31, to realize a second power saving function (e.g., Japanese Patent Application Laid-open No. 2011-061300). It can be set whether to enable or disable start of the monitor power saving utility program 203 when the OS 201 starts.

The power saving setting application program 202 is software for setting a power saving function of the computer 10. In addition to setting of the power saving function of the computer 10, the power saving setting application program 202 also performs monitoring processing for acquiring information indicating usage of the computer 10 as log information and processing for analyzing the log information to determine whether to prompt the user to execute the monitor power saving utility program 203, for example.

The Northbridge 102 is a bridge device that connects a local bus of the CPU 101 and the Southbridge 104. The Northbridge 102 contains a memory controller that performs access control on the main memory 103. The Northbridge 102 also has a function to communicate with the GPU 105 via a serial bus of the PCI Express standard.

The GPU 105 is a display controller that controls the LCD 17 used as a display monitor of the computer 10. A display signal generated by the GPU 105 is transmitted to the LCD 17.

The Southbridge 104 controls each device on a low pin count (LPC) bus and each device on a peripheral component interconnect (PCI) bus. Furthermore, the Southbridge 104 contains an integrated drive electronics (IDE) controller for controlling the HDD 109 and the ODD 20. The Southbridge 104 also has a function to communicate with each of the Bluetooth module 108, the camera controller 110, and the sound controller 106. The sound controller 106 is an audio source device, and outputs audio data to be reproduced to the speakers 18A and 18B. The camera controller 110 inputs video captured by the camera 31 to the Southbridge 104. Furthermore, the Southbridge 104 contains an SD card controller that controls a card device (an SD card) attached to the SD card slot 22 in a removable manner and a USB controller that controls a USB device connected to the USB port 23 in a removable manner.

The IEEE 1394 controller 113, the wired LAN controller 114, the wireless LAN controller 115, and the like are connected to the PCI bus.

The IEEE 1394 controller 113 communicates with an external device via a serial bus of the IEEE 1394 standard. The wired LAN controller 114 is a communication device that performs communications of the IEEE 802.3 standard, for example. The wireless LAN controller 115 is a wireless communication device that performs wireless communications of the IEEE 802.11 standard, for example.

The EC/KBC 116 is a one-chip microcomputer in which an embedded controller for power management and a keyboard controller for controlling the KB 13 and the pointing device 16, such as a mouse, are integrated, for example.

The EC/KBC 116 has a function to turn ON or turn OFF the computer 10 in response to an operation on the power switch 14 performed by the user in cooperation with the power circuit 24.

The power circuit 24 uses electric power supplied from the outside via the AC adapter 30 or electric power supplied from the battery 25 to supply electric power to each module in the computer 10. In other words, the computer 10 is driven by the electric power supplied from an external power source, such as an AC commercial power source, or the electric power supplied from the battery 25. The AC adapter 30 may be provided in the computer 10. The power circuit 24 has a function to determine whether electric power is supplied from an external power source to the computer 10 via the AC adapter 30. If electric power is supplied from an external power source to the computer 10, the power circuit 24 uses the electric power supplied from the external power source to supply electric power to each module in the computer 10. By contrast, if no electric power is supplied from an external power source to the computer 10, the power circuit 24 uses electric power supplied from the battery 25 to supply electric power to each module in the computer 10. Furthermore, the power circuit 24 retains information on the remaining amount of the electric power in the battery 25.

The EC/KBC 116 has a function to turn ON or OFF each of the Bluetooth (Registered Trademark) module 108 and the wireless LAN controller 115 in response to an operation on the wireless communication switch 19. If the wireless communication switch 19 is set to an OFF position, both the Bluetooth (Registered Trademark) module 108 and the wireless LAN controller 115 are set to an OFF state (a power-OFF state).

The EC/KBC 116 also has a function to control the illuminance sensor 21. The illuminance sensor 21 is a sensor that measures the illuminance of an environment in which the computer 10 is used.

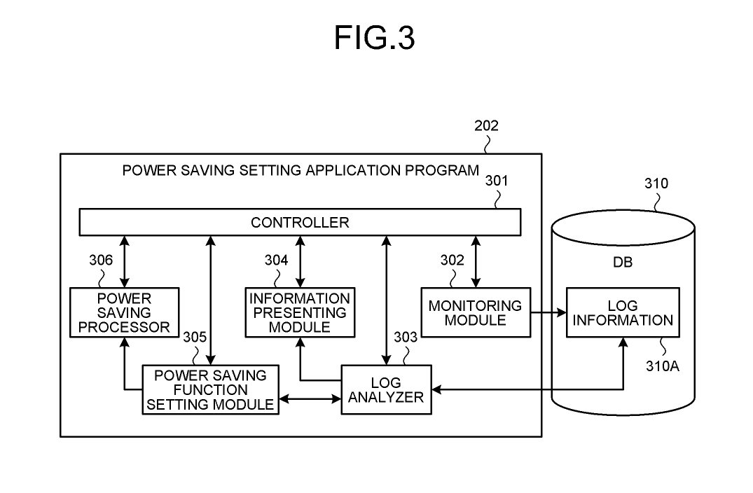

The power saving setting application program 202 will now be described. FIG. 3 is a block diagram of a functional configuration of the power saving setting application program 202 in the embodiment.

The power saving setting application program 202 comprises a controller 301, a monitoring module 302, a log analyzer 303, an information presenting module 304, a power saving function setting module 305, and a power saving processor 306. The power saving setting application program 202 performs processing for reading or writing data from or to a database 310. The database 310 is a storage device, such as the HDD 109, that stores therein log information 310A, for example.

The controller 301 controls operations of each module of the power saving setting application program 202.

The power saving function setting module 305 functions as a power saving function setting module, and sets a power saving parameter in accordance with setting performed by the user or with recommendation values determined in advance. The power saving parameter is a parameter specifying the contents of the power saving function. The power saving parameter is a parameter applied to several devices determined in advance in the computer 10. In other words, the power saving parameter indicates the contents of a first power saving function applied to each device.

More specifically, the power saving parameter contains a plurality of parameter values each specifying power consumption of each module in the computer 10, heat control conditions of each module in the computer 10, the processing speed of the CPU 101, the usage of the main memory 103, the luminance of the LCD 17, the brightness of a backlight, a time until the LCD 17 is turned OFF, a time until the HDD 109 is turned OFF, a time until the ODD 20 is turned OFF, a time until the system is put into a sleep state, and a time until the computer 10 is put into an idle state, for example. The power saving parameter further contains a plurality of parameter values each specifying power-ON or power-OFF of predetermined input/output (I/O) devices in the computer 10, such as the sound controller 106, the speakers 18A and 18B, the ODD 20, the Bluetooth (Registered Trademark) module 108, the wired LAN controller 114, the wireless LAN controller 115, the SD card controller that controls communications with an SD card inserted into the SD card slot 22, and the USB controller that controls communications with a device connected to the USB port 23.

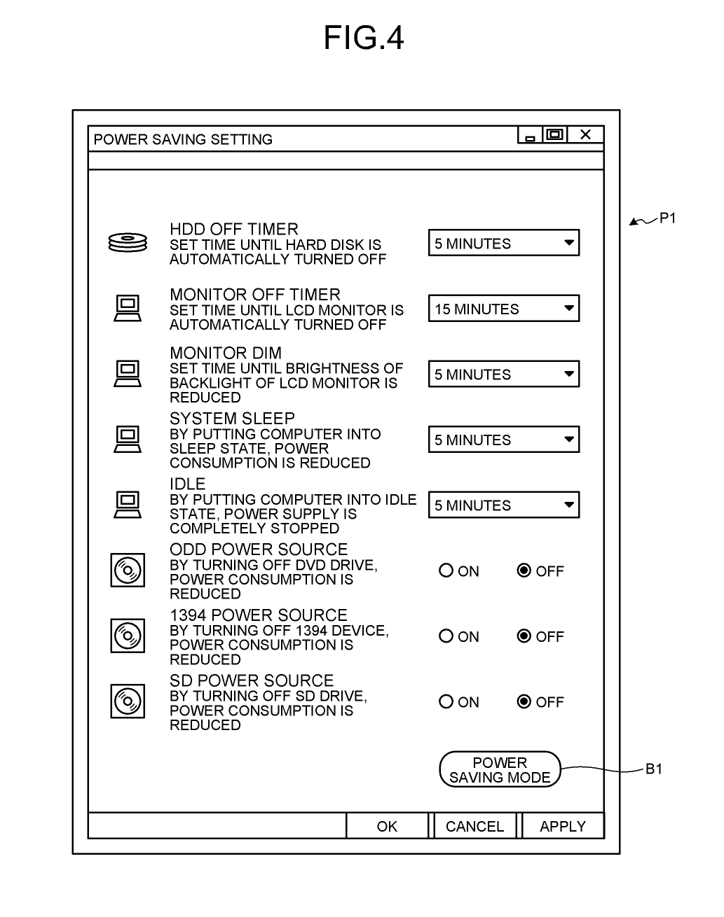

FIG. 4 is a front view of an example of a power saving setting screen P1 displayed by the power saving function setting module 305 in the embodiment.

As illustrated in FIG. 4, the power saving function setting module 305 displays values each indicating the time until the HDD 109 is turned OFF, the time until the LCD 17 is turned OFF, the time until the brightness of the backlight is reduced, the time until the system is put into the sleep state, the time until the computer 10 is put into the idle state, and power-ON or power-OFF of the predetermined I/O devices (e.g., the ODD 20, the IEEE 1394 device, and the SD card) as the power saving parameter on the power saving setting screen P1. Lists for selecting a time are displayed for the power saving parameter indicating the time until the HDD 109 is turned OFF, the time until the LCD 17 is turned OFF, the time until the brightness of the backlight is reduced, the time until the system is put into the sleep state, and the time until the computer 10 is put into the idle state. Buttons (radio buttons) for selecting power-ON or power-OFF are displayed for the power saving parameter indicating power-ON or power-OFF of the ODD 20, power-ON or power-OFF of the IEEE 1394 device, and power-ON or power-OFF of the SD card.

The user can confirm and change the power saving parameter on the power saving setting screen P1 illustrated in FIG. 4.

In addition, the power saving function setting module 305 retains in advance recommended values of the power saving parameter in a power saving mode in which power consumption is optimized to provide an extremely large power saving effect. If the power saving mode is selected, the power saving function setting module 305 automatically sets the recommended values of the power saving parameter in the power saving mode on the power saving setting screen P1 as the values of the power saving parameter. In the embodiment, if an operation is performed on a power saving mode button B1 provided to the power saving setting screen P1 illustrated in FIG. 4, the power saving function setting module 305 automatically sets the recommended values of the power saving parameter in the power saving mode on the power saving setting screen P1 as the values of the power saving parameter.

The power saving processor 306 functions as a power saving processor, and controls each module in the computer 10 in accordance with the values of the power saving parameter set by the power saving function setting module 305. In other words, if the time until the LCD 17 is turned OFF, which is the power saving parameter, is set to 10 minutes, and the LCD 17 is being displayed for equal to or longer than 10 minutes without any operation performed by the user, for example, the power saving processor 306 turns OFF the LCD 17. Furthermore, if the power saving parameter indicating power-ON or power-OFF of the ODD 20 is set to OFF, for example, the power saving processor 306 turns OFF the ODD 20.

The power saving processor 306 displays power consumption in a graph (in real time, or in units of days, weeks, or months), which is not illustrated in particular. This enables the user to visually check for a change in the power consumption when a mode is switched to the power saving mode, for example.

In the case where the values of the power saving parameter are set on the power saving setting screen P1 as described above, there are disadvantages as follows:

(1) Because turning OFF of the LCD 17 during an operation (e.g., while checking out the Web or documents) decreases the usability, the user might set the time until the LCD 17 is turned OFF to “None” so as to be able to use the computer 10. In this case, the power consumption cannot be reduced, thereby not being able to use the power saving setting screen P1 aiming for power saving, effectively.

(2) Because the LCD 17 have been turned OFF many times during an operation (e.g., while checking out the Web or documents), the user might operate the KB 13 or the pointing device 16, such as a mouse, every time immediately after the LCD 17 is turned OFF in order to restore normal display. In this case, the values of the power saving parameter set on the power saving setting screen P1 by the user do not meet the current conditions. As a result, the power consumption cannot be reduced, and the user feels stress. In particular, if the recommended values of the power saving parameter in the power saving mode are set on the power saving setting screen P1 as the values of the power saving parameter, the time until the LCD 17 is turned OFF is set to be shorter, thereby increasing this tendency. To address this, the user only needs to change the values of the power saving parameter on the power saving setting screen P1. However, many users put up with the inconvenience for power saving or leave the setting unchanged because they have no idea how to change the setting.

(3) Although the user leaves his/her seat or stops using the computer 10 for many times, the time until the LCD 17 is turned OFF may be set to too long so that the user needs to frequently turn OFF the LCD 17 for himself/herself before the set time has elapsed. In this case, the values of the power saving parameter set on the power saving setting screen P1 by the user also do not meet the current conditions. As a result, the power saving setting screen P1 aiming for power saving cannot be used effectively.

To address these disadvantages, in the embodiment, the power saving setting application program 202 detects a state corresponding to the cases (1) to (3) described above. Subsequently, by guiding the user to execute the monitor power saving utility program 203 that performs ON/OFF control on the LCD 17 depending on the detection state of the face of the user with the camera 31 for power saving that is expected to provide a larger power saving effect depending on usage by the user, the disadvantages in the state corresponding to the cases (1) to (3) described above are addressed.

The monitoring module 302 functioning as a monitoring module monitors usage of each module in the computer 10, and acquires information indicating the usage of each module. The information indicating the usage of each module also contains values of the frequency of use, the hour of use, and the amount of use of each module, for example. The monitoring module 302 acquires the information indicating the usage of each module every predetermined period of time or when an event occurs in each module, for example. The monitoring module 302 stores the information thus acquired in the database 310 as the log information 310A at any time along with information of the date and time of the acquisition. Therefore, the log information 310A indicating the usage of the computer 10 in a long period of time is accumulated in the database 310.

Examples of monitoring items contained in the log information 310A indicating the usage of each module in the computer 10 monitored by the monitoring module 302 include power-ON or power-OFF of the LCD 17, DIM (reduction in the brightness of the backlight) of the LCD 17, and input supplied from a human interface device (HID), such as the KB 13 and the pointing device 16 like a mouse.

The monitoring module 302 monitors a command issued from a corresponding module, that is, from the EC/KBC 116 as the input supplied from the HID, such as the KB 13 and the pointing device 16 like a mouse, and counts the number of commands.

The log analyzer 303 functioning as an analyzer reads the log information 310A from the database 310, and analyzes the log information 310A thus read. The log analyzer 303 calculates a predetermined value from statistical information of the log information 310A within a predetermined period of time, and determines whether to guide the user to execute the monitor power saving utility program 203 based on the calculation result. If the log analyzer 303 determines to guide the user to execute the monitor power saving utility program 203, the log analyzer 303 outputs the fact to the information presenting module 304.

The predetermined period of time is a period of time in units of days, months, or years, for example. Therefore, if the predetermined period of time is set to two days, for example, the log analyzer 303 determines whether to guide the user to execute the monitor power saving utility program 203 on Feb. 1, 2012 based on the statistical information from Jan. 30, 2012 to Jan. 31, 2012.

The log analyzer 303 extracts, from the log information 310A, a number of times the normal display of the LCD 17 is restored by the input supplied from the HID, such as the KB 13 or the pointing device 16 like a mouse, from power-OFF of the LCD 17 performed by the power saving processor 306 or DIM (reduction in the brightness of the backlight) of the LCD 17 performed by the power saving processor 306. The log analyzer 303 then calculates a number of times per hour the normal display of the LCD 17 is restored, within the predetermined period of time.

As the number of times per hour, within the predetermined period of time, the normal display of the LCD 17 is restored by the input supplied from the HID from the power-OFF of the LCD 17 or the DIM of the LCD 17 performed by the power saving processor 306 (a number of times of restoration per hour) is large, the values of the power saving parameter set on the power saving setting screen P1 do not meet the current conditions. To address this, if the number of times per hour of restoration from the power-OFF of the LCD 17 performed by the power saving processor 306 exceeds a predetermined threshold (e.g., once/hour), the log analyzer 303 determines to guide the user to execute the monitor power saving utility program 203. Furthermore, if the number of times per hour of restoration from the DIM of the LCD 17 performed by the power saving processor 306 exceeds a predetermined threshold (e.g., 2.5 times/hour), the log analyzer 303 determines to guide the user to execute the monitor power saving utility program 203.

The thresholds described above (e.g., once/hour and 2.5 times/hour) are determined based on the correlation between an increment in the number of times per hour of restoration from the power-OFF of the LCD 17 or an increment in the number of times per hour of restoration from the DIM of the LCD 17 and the stress level of the user associated with the restoration, for example. In other words, it is assumed that the user who undergoes the restoration more often tends to feel more stress.

Furthermore, the log analyzer 303 extracts, from the log information 310A, a number of times the normal display of the LCD 17 is restored within a predetermined time (e.g., within 15 seconds) by the input supplied from the HID, such as the KB 13 and the pointing device 16 like a mouse, from DIM (reduction in the brightness of the backlight) of the LCD 17 performed by the power saving processor 306. The log analyzer 303 then calculates a number of times per hour the normal display of the LCD 17 is restored, within the predetermined period of time.

As the number of times per hour, within the predetermined period of time, the normal display of the LCD 17 is restored within the predetermined time by the input supplied from the HID from the DIM of the LCD 17 performed by the power saving processor 306 (a number of times of restoration per hour), the values of the power saving parameter set on the power saving setting screen P1 do not meet the current conditions. To address this, if the number of times per hour of restoration within the predetermined time from the DIM of the LCD 17 performed by the power saving processor 306 exceeds a predetermined threshold (e.g., 3 times/hour), the log analyzer 303 determines to guide the user to execute the monitor power saving utility program 203.

The threshold described above (e.g., three times/hour) is determined based on the correlation between an increment in the time required for restoration from the power-OFF of the LCD 17 in each restoration or an increment in the time required for restoration from the DIM of the LCD 17 in each restoration and the stress level of the user associated with the restoration, for example. In other words, it is assumed that the user who undergoes the restoration in a shorter time tends to feel more stress.

Furthermore, the log analyzer 303 monitors the power saving parameter set by the power saving function setting module 305 via the power saving setting screen P1. If the power saving parameter on the time until the LCD 17 is turned OFF is set to “No setting”, for example, the log analyzer 303 determines to guide the user to execute the monitor power saving utility program 203.

The information presenting module 304 functions as a notification module, and displays a guidance message for guiding the user to execute the monitor power saving utility program 203 determined by the log analyzer 303 on the LCD 17. By checking for the guidance message thus displayed for guiding the user to execute the monitor power saving utility program 203, the user can start the monitor power saving utility program 203.

FIG. 5 is a front view of an example of a screen with the guidance message in the embodiment. As illustrated in FIG. 5, the LCD 17 displays a screen P2 with a guidance message M, “TIME UNTIL MONITOR IS TURNED OFF IS CHANGED TO ‘NONE’. IF YOU USE MONITOR POWER SAVING UTILITY PROGRAM, YOU CAN AUTOMATICALLY TURN ON/OFF MONITOR CONVENIENTLY. WOULD YOU LIKE TO START PROGRAM NOW?” as the guidance message for guiding the user to execute the monitor power saving utility program 203. To start the monitor power saving utility program 203 after checking for the guidance message M thus displayed, the user selects a “YES” button B2 with the pointing device 16, such as a mouse, making it possible to enable start of the monitor power saving utility program 203 and to start the monitor power saving utility program 203. By contrast, not to start the monitor power saving utility program 203 after checking for the prompt message M thus displayed, the user selects a “NO” button B3 with the pointing device 16, such as a mouse.

The information presenting module 304 may display the guidance message M for guiding the user to execute the monitor power saving utility program 203 along with the power saving setting screen P1 and the power consumption displayed in a graph described above. If the information presenting module 304 displays the guidance message M along with the power saving setting screen P1, the user can start the monitor power saving utility program 203 while confirming the values of the power saving parameter on the power saving setting screen P1.

The power saving setting application program 202 is realized as a resident program that starts in response to start of the OS 201 and terminates in response to termination of the OS 201. While the OS 201 is operating (while the computer 10 is being turned ON), the power saving setting application program 202 monitors the usage of the computer 10 by the user to acquire information indicating the usage of each module. Alternatively, the power saving setting application program 202 may use only the monitoring module 302 that monitors the usage of the computer 10 by the user as a resident program, and may use the log analyzer 303, the information presenting module 304, the power saving function setting module 305, and the power saving processor 306 used for guiding the user to execute the monitor power saving utility program 203 as programs executed every predetermined period of time or only when a request from the user is received.

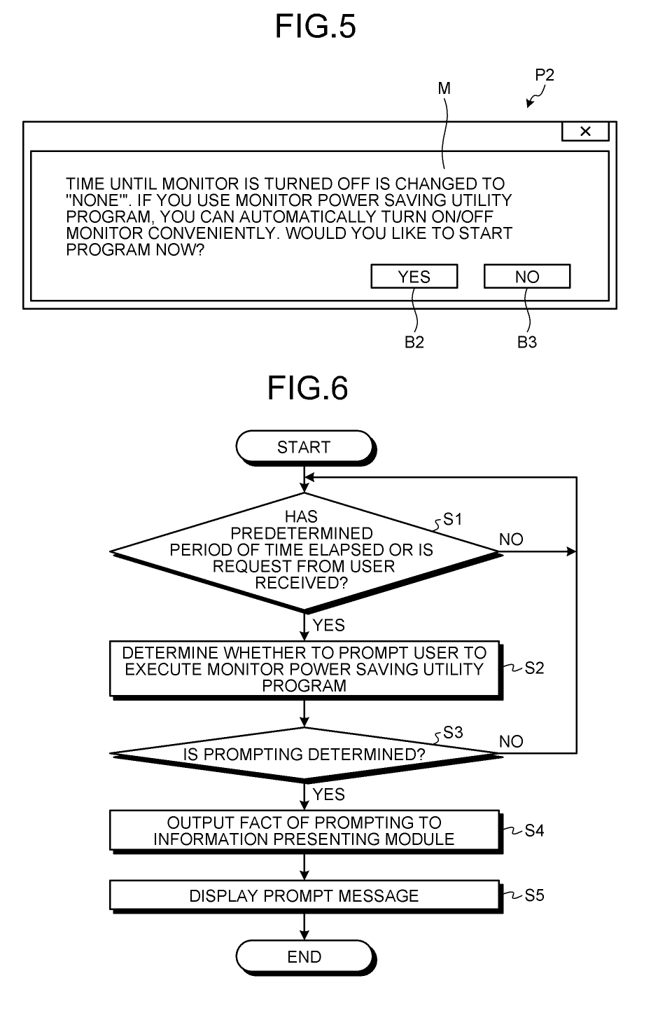

An example of a process of monitor power saving utility guiding processing performed by the computer 10 will now be described with reference to a flowchart of FIG. 6.

As illustrated in FIG. 6, if a predetermined period of time has elapsed or if a request from the user is received (Yes at S1), the log analyzer 303 reads the log information 310A from the database 310 when the computer 10 starts. The log analyzer 303 then analyzes the log information 310A thus read and the power saving parameter set by the power saving function setting module 305 via the power saving setting screen P1 to determine whether to guide the user to execute the monitor power saving utility program 203 (S2).

If the log analyzer 303 determines to guide the user to execute the monitor power saving utility program 203 (Yes at S3), the log analyzer 303 outputs the fact that it is determined to guide the user to execute the monitor power saving utility program 203, to the information presenting module 304 (S4).

By contrast, if the log analyzer 303 does not determine to guide the user to execute the monitor power saving utility program 203 (No at S3), the log analyzer 303 returns to S1, and waits until the predetermined period of time has elapsed or until a request from the user is received.

Subsequently, the information presenting module 304 displays a guidance message for guiding the user to execute the monitor power saving utility program 203 determined by the log analyzer 303 on the LCD 17 (S5).

As described above, according to the embodiment, if it is analyzed that power saving by the first power saving function is not achieved as a result of when the power saving processor controls each module in accordance with the value of the power saving parameter in the first power saving function, a user is notified to use the second power saving function. Here, the second power saving function is expected to provide a larger power saving effect than that of the first power saving function and realizes power saving depending on the usage of each module. As a result, a setting that reduces the usability for the user or a user setting providing a smaller power saving effect is detected, and a message for notifying the user to use the second power saving function expected to provide a larger power saving effect depending on the usage by the user is displayed. Therefore, it becomes possible to recommend to a user a method of use, which can realize more efficient power saving.

The power saving setting application program 202 executed in the computer 10 according to the embodiment is provided in a manner recorded in a computer-readable recording medium, such as a compact disk read-only memory (CD-ROM), a flexible disk (FD), a compact disk recordable (CD-R), and a digital versatile disk (DVD), as a file in an installable or executable format.

The power saving setting application program 202 executed in the computer 10 according to the embodiment may be provided in a manner stored in a computer connected to a network such as the Internet to be made available for downloads via the network. Furthermore, the power saving setting application program 202 executed in the computer 10 according to the embodiment may be provided or distributed over a network such as the Internet.

The power saving setting application program 202 according to the embodiment may be provided in a manner incorporated in a ROM and the like in advance.

The power saving setting application program 202 executed in the computer 10 according to the embodiment has a module configuration comprising each module described above (the controller 301, the monitoring module 302, the log analyzer 303, the information presenting module 304, the power saving function setting module 305, and the power saving processor 306). In actual hardware, the CPU (processor) reads and executes the power saving setting application program 202 from the storage medium described above to load each module on the main memory. Thus, the controller 301, the monitoring module 302, the log analyzer 303, the information presenting module 304, the power saving function setting module 305, and the power saving processor 306 are generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a power saving function setting module configured to specify a first value as a first power saving function, the first value set to a power saving parameter for power saving by modules;
a power saving processor configured to control the modules in accordance with the first value of the power saving parameter in the first power saving function;
a monitoring module configured to accumulate in a storage device information indicating usage of the modules as log information;
an analyzer configured to determine based on the accumulated log information whether power saving is achieved by the first power saving function when the power saving processor controls the modules in accordance with the first value of the power saving parameter in the first power saving function; and
a notification module configured to notify a user to use a second power saving function when power saving by the first power saving function is not achieved, the second power saving function expected to provide a larger power saving effect than a power saving effect of the first power saving function and configured to realize power saving in accordance with the usage of the modules.

2. The information processor of claim 1, wherein when a number of times per unit time that a display is restored by a user operation from a state in which the display has been turned OFF by the power saving processor exceeds a first threshold, the analyzer is configured to determine that power saving by the first power saving function is not achieved.

3. The information processor of claim 1, wherein when a number of times per unit time that a display is restored by a user operation from a state in which brightness of a backlight of the display has been reduced by the power saving processor exceeds a first threshold, the analyzer is configured to determine that power saving by the first power saving function is not achieved.

4. The information processor of claim 1, wherein when a number of times per unit time that a display is restored within a first time by a user operation from a state in which brightness of a backlight in a display is reduced by power saving processor exceeds a first threshold, the analyzer is configured to determine that power saving by the first power saving function is not achieved.

5. A computer program product having a non-transitory computer readable medium including programmed instructions, wherein the instructions, when executed by a computer, cause the computer to perform:
specifying a first value as a first power saving function, the first value set to a power saving parameter for power saving by modules;
controlling the modules in accordance with the first value of the power saving parameter in the first power saving function;
accumulating in a storage device information indicating usage of the modules as log information;
determining determine based on the accumulated log information whether power saving is achieved by the first power saving function when the controlling controls the modules in accordance with the first value of the power saving parameter in the first power saving function; and
notifying a user to use a second power saving function when power saving by the first power saving function is not achieved, the second power saving function expected to provide a larger power saving effect than a power saving effect of the first power saving function and configured to realize power saving in accordance with the usage of the modules.

6. A power saving setting method comprising:
specifying a first value as a first power saving function, the first value set to a power saving parameter for power saving by modules;
controlling with a processor the modules in accordance with the first value of the power saving parameter in the first power saving function;
accumulating in a storage device information indicating usage of the modules as log information;
determining based on the accumulated log information whether power saving is achieved by the first power saving function when the modules are controlled in accordance with the first value of the power saving parameter in the first power saving function; and
notifying a user to use a second power saving function when power saving by the first power saving function is not achieved, the second power saving function expected to provide a larger power saving effect than a power saving effect of the first power saving function and configured to realize power saving in accordance with the usage of the modules.
